(19) United States
(12) Patent Application Publication
(10) Pub. No.: US 2005/0005618 A1
(43) Pub. Date: Jan. 13, 2005

(54) Refrigerator with temperature-range indication

(75) Inventor: Michael Neumann, Ulm (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/916,040

(22) Filed: Aug. 11, 2004

Related U.S. Application Data
(63) Continuation of application No. PCT/EP03/00975, filed on Jan. 31, 2003.

(30) Foreign Application Priority Data
Feb. 11, 2002 (DE) 102 05 589.0

(51) Int. Cl. F25B 49/00; G01K 13/00; F25D 21/06

(52) U.S. Cl. 62/126; 62/129

(57) ABSTRACT

A refrigerating appliance includes a refrigerating compartment enclosed by a housing and by a door. Inside the compartment is an overall, local and temporal fluctuation range of the temperatures prevalent therein. The refrigerating compartment can be subdivided into a number of areas, inside of which the regional, local and temporal fluctuation range of temperatures prevalent therein is smaller than the overall fluctuation range. An indicating element for indicating an item of information, which depicts the temperature interval prevalent within the area, is associated with at least one of the areas.

### CROSS-REFERENCE TO RELATED APPLICATION

This application is a continuation, under 35 U.S.C. § 120, of copending international application No. PCT/EP03/00975, filed Jan. 31, 2003, which designated the United States; this application also claims the priority, under 35 U.S.C. § 119, of German patent application No. 102 05 589.0, filed Feb. 11, 2002; the prior applications are herewith incorporated by reference in their entirety.

### BACKGROUND OF THE INVENTION

### FIELD OF THE INVENTION

The present invention relates, in general terms, to a refrigerator having at least one refrigerating compartment that is enclosed by a housing and a door and has a global local and temporal fluctuation bandwidth of the temperatures prevailing therein.

The temporal fluctuation bandwidth of the temperature generally results from the intermittent operation of the refrigerating machine of such a refrigerator, and the local fluctuation bandwidth results from the refrigerating compartment generally being cooled just from one side, although it is possible for heat to penetrate from all directions, through the enclosing housing, into the refrigerating compartment and the quality of insulation is not the same everywhere. If no countermeasures are taken, this generally results in a temperature gradient in the refrigerating compartment that ranges from relatively high temperatures in the top region of the refrigerating compartment in the vicinity of the door to low temperatures in the bottom region of the compartment in the vicinity of the rear wall. Although a fair number of modern refrigerators are provided with a digital temperature display that can display a temperature prevailing in a refrigeration compartment, it is not readily apparent to the user as to which region of the refrigerating compartment the temperature display is actually referring and how much the actual temperature in other regions of the refrigerating compartment, in the upward or downward direction, may differ from the value displayed.

Such differences in temperature are desirable to a certain extent because not all foodstuffs can be optimally stored at the same temperature. Grave problems may arise, however, if foodstuffs affected by germs such as salmonella or listeria are stored at temperatures that are unsuitable for them. In particular, in the case of listeria, which, in recent years, has resulted in cases of illness in various European countries, it is known that listeria can multiply at refrigerator temperatures. As a result, it is necessary to ensure sufficiently cold storage of foodstuffs that may potentially contain these germs.

This is difficult for the user, in the case of conventional refrigerators because he/she does not know the temperature distribution in the interior of the refrigerator. The manufacturer of such a refrigerator may, if need be, give recommendations, in the associated directions for use, as to which foodstuff should be stored in which regions of the interior at a typical thermostat setting of the refrigerator. However, because it is not generally necessary to consult the directions for use to be able to utilize the refrigerator, there is a high probability of such information not being noted or put into practice by the users.

Even in the case of foodstuffs that do not contain any harmful germs, it is possible for these not to be stored under optimum conditions and, therefore, to lose quality, and spoil, prematurely.

### SUMMARY OF THE INVENTION

It is accordingly an object of the invention to provide a refrigerator with temperature-range indication that overcomes the hereinafore-mentioned disadvantages of the heretofore-known devices of this general type and that makes it easier for a user to store different articles in a common refrigerator compartment in each case under different storage conditions that are optimum for each of the articles.

With the foregoing and other objects in view, there is provided, in accordance with the invention, a refrigerator, including a housing defining at least one refrigerating compartment having a global local and temporal fluctuation bandwidth of temperatures prevailing therein, regions each having a regional local and temporal fluctuation bandwidth of temperatures prevailing therein smaller than the global fluctuating bandwidth, and a display element associated with at least one of the regions for displaying information representative of a temperature interval prevailing in the at least one of the regions, and a door removably closing off the compartment.

According to the invention, at least one region in the interior of the refrigerating compartment that has a regional local and temporal fluctuation bandwidth of the temperature prevailing therein that is smaller than the global local and temporal fluctuation bandwidth of the refrigeration compartment as a whole is associated with a display element for displaying information that is representative of a temperature interval prevailing in this region.

In the simplest case, this information may be numeral temperature information, in particular, information giving the average temperature of the region or a top and bottom limit of the temperature interval. A variant that is more convenient for a user is one in which the information that is to be displayed is indications, in each case, of foodstuffs that can, advantageously, be stored in the relevant region. This information may be present in text form or in pictographic form. The lateral alternative is preferred because it does not require the refrigerator to be adapted to the language of the potential users.

In accordance with another feature of the invention, to make it easier for different articles to be sorted into suitable regions of the refrigerating compartment, the display element is, preferably, fitted in the refrigerating compartment locally in relation to the region to which it is associated. As an alternative, or in addition, the display element may also be fitted on a front side of the housing of the refrigerator such that its relationship to the respective region is apparent.

In accordance with a further feature of the invention, subdivision of the refrigerating compartment into regions can take place, on one hand, in the horizontal direction, by dividing up the refrigerating compartment into a first group of one or more relatively warm regions in the vicinity of the door and a second group of one or more regions remote from the door, which are generally colder, in contrast. In the case of the refrigerating compartment being divided up vertically, a shelf disposed in the refrigerating compartment can form a boundary between regions.

Although it is conceivable, in general, to provide the display element with fixed information, e.g., in the form of an imprint, it is preferred for the display element to be set up to display changing information that can be adapted to the temperature conditions currently prevailing in a refrigerator in each case.

In accordance with an added feature of the invention, the display element is fitted on a front side of the housing.

In accordance with an additional feature of the invention, the changing information is numerical temperature information and/or text and/or pictographic indications of articles to be stored in at least one of the regions.

A first possible way of providing for such adaptation is to couple the display element to a temperature sensor for sensing a temperature in the associated region. Coupling, here, may take place substantially as desired; it is conceivable, for example, to have an electrical coupling between a thermocouple and an electrically activate display element, for example, an LED or LCD display, a “mechanical” coupling, for example, by way of the liquid column in a thermometer, of which the supply container can be taken to be the temperature sensor and its scale can be taken to be the display element, within the context of the present invention, or even for the sensor and the display element to be identical, if, for example, a material with coloring that varies in dependence on the temperature is used as the temperature sensor.

In accordance with yet another feature of the invention, a refrigerating unit and a control unit programmed to control operation of the refrigerating unit based upon a predetermined desired temperature and at least one temperature sensed in the housing and to activate the display element dependent upon the at least one temperature sensed.

Instead of the temperature being sensed directly in the relevant region, however, it is also possible for the temperature prevailing there to be estimated by way of at least one temperature measured at another location of the refrigerator, as long as the relationship between the temperature or temperatures measured and the temperature of the region is known. For such a purpose, use will, preferably, be made of at least one temperature sensor for sensing a temperature in the interior of the refrigeration compartment and at least one temperature sensor for sensing a temperature in the surroundings of the refrigerator. The temperature prevailing in the relevant region or the information that is to be displayed on the display element can easily be determined by way of a table, in dependence on the temperatures measured.

A temperature sensor that is used within the context of the invention for sensing a temperature in the interior of the refrigerating compartment should have a large time constant. As a result, periodic fluctuations in the temperature that arise from the intermittent operation of the refrigerating machine are substantially not reflected in the sensing result of the sensor. As a result of a first variant, this large time constant may be realized with the aid of an electronic average circuit. This variant is expedient, in particular, if the same temperature sensor is also used for the thermostatic regulation of the operation of the refrigerating machine; in this case, it is possible to pick up a first output signal of the temperature sensor for the thermostatic regulation prior to the electronic averaging.

In accordance with yet a further feature of the invention, the control unit is connected to at least one of the first temperature sensor and the second temperature sensor.

In accordance with yet an added feature of the invention, the control unit has an information table to be displayed in dependence upon values of the sensed temperature in the refrigerator compartment and the sensed temperature in the environment of the housing.

In accordance with yet an additional feature of the invention, the refrigerating unit operates intermittently and the first temperature sensor senses a temperature averaged with a time constant selected to average out temperature fluctuations associated with the intermittent operation of the refrigerating unit.

In accordance with again another feature of the invention, the first temperature sensor has an electronic average circuit.

With the objects of the invention in view, in a refrigerator having a housing defining at least one refrigerating compartment and a door removably closing off the compartment, the compartment having a global local and temporal fluctuation bandwidth of temperatures prevailing therein and regions each having a regional local and temporal fluctuation bandwidth of temperatures prevailing therein smaller than the global fluctuating bandwidth, there is also provided a display device including a display element associated with at least one of the regions for displaying information representative of a temperature interval prevailing in the at least one of the regions.

With the objects of the invention in view, there is also provided a refrigerator, including a housing defining at least one refrigerating compartment having a global fluctuation bandwidth of temperatures prevailing therein, regions each having a regional fluctuation bandwidth of temperatures prevailing therein smaller than the global fluctuating bandwidth, the regions including at least one region in a vicinity of the door and at least one region remote from the door, and a display element disposed is at least one of the regions for displaying information representative of a temperature interval prevailing in the at least one of the regions, a door removably closing off the compartment.

Other possible ways of rendering the temperature sensor highly sluggish are constituted by fitting a thermally insulating material between a temperature-sensitive element of the sensor and the surroundings thereof to slow down temperature equalization between the two, and by providing a heat store in thermal contact with the temperature-sensitive element and the surroundings of the temperature sensor.

Other features that are considered as characteristic for the invention are set forth in the appended claims.

Although the invention is illustrated and described herein as embodied in a refrigerator with temperature-range indication, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a perspective front view of a refrigerator according to the invention with a door in an open position;

FIG. 2 is a front elevational view of a first embodiment of a display element for the refrigerator of FIG. 1;

FIG. 3 is a cross-sectional view through the display element of FIG. 2 along section line III-III;

FIG. 4 is a front elevational view of a second embodiment of a display element for the refrigerator of FIG. 1;

FIG. 5 is a cross-sectional view through the display element of FIG. 4 along section line V-V; and

FIG. 6 is a schematic and block circuit diagram of parts of a refrigerator according to the invention in a third embodiment.

### DESCRIPTION OF THE PREFERRED EMBODIMENTS

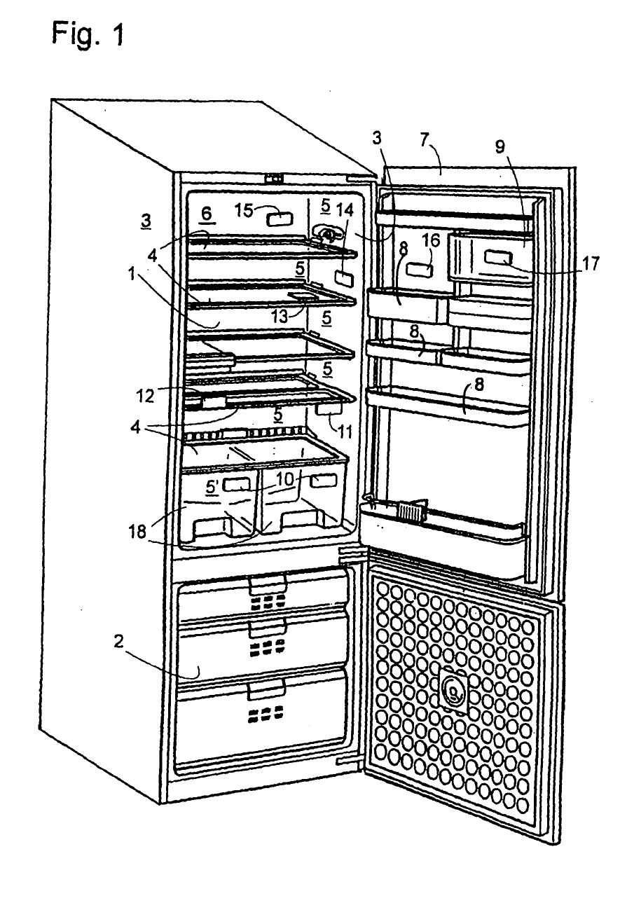

Referring now to the figures of the drawings in detail and first, particularly to FIG. 1 thereof, there is shown a perspective view of a refrigerator according to the invention with the door 7 open. The refrigerator illustrated is a fridge/freezer combination with a refrigerating compartment 1 located at the top and a freezer compartment 2 located at the bottom. Because, within a freezer compartment, the differences in temperature between the warmest and coldest points are generally smaller than in a refrigerating compartment and the temperatures prevailing in the freezer compartment are generally so low that there is basically no difference between the warmest and coldest point as far as their suitability for storing different articles is concerned, the invention is preferably realized in the region of the refrigerating compartment and will, thus, be described hereinbelow with reference to the refrigerating compartment 1.

The refrigerating compartment 1 is subdivided in the vertical direction, by shelves 4 suspended on the side walls 3 of the housing, into a plurality of sub-compartments or regions 5, 5′. The two lowermost regions 5′ are each delimited by a drawer 18; the regions 5 located above are open in the direction of the door 7 and are cooled by an evaporator that cannot be seen in FIG. 1 but is disposed behind the rear wall 6 of the refrigerating compartment 1, level with the regions 5. In each of these regions 5, there is a non-vanishing temperature gradient from a coldest location at the rear wall 6 to a warmest location in the vicinity of the door 7. Because the cold air in the refrigerating compartment 1 tends to descend, the lower-level regions 5 are, generally, colder than the higher-level regions; i.e., the global temperature difference between the warmest and the coldest points of the refrigerating compartment 1 as a whole is greater than the differences in temperature in the individual regions 5 in each case. The regions 5′ are warmer, on average, than the regions 5 because they are not in direct thermal contact with the evaporator.

A group of comparative warm regions is formed by article supports 8 installed on the door 7. The warmest of these regions is a butter compartment 9, which is separated off by a shutter from the rest of the refrigerating compartment 1.

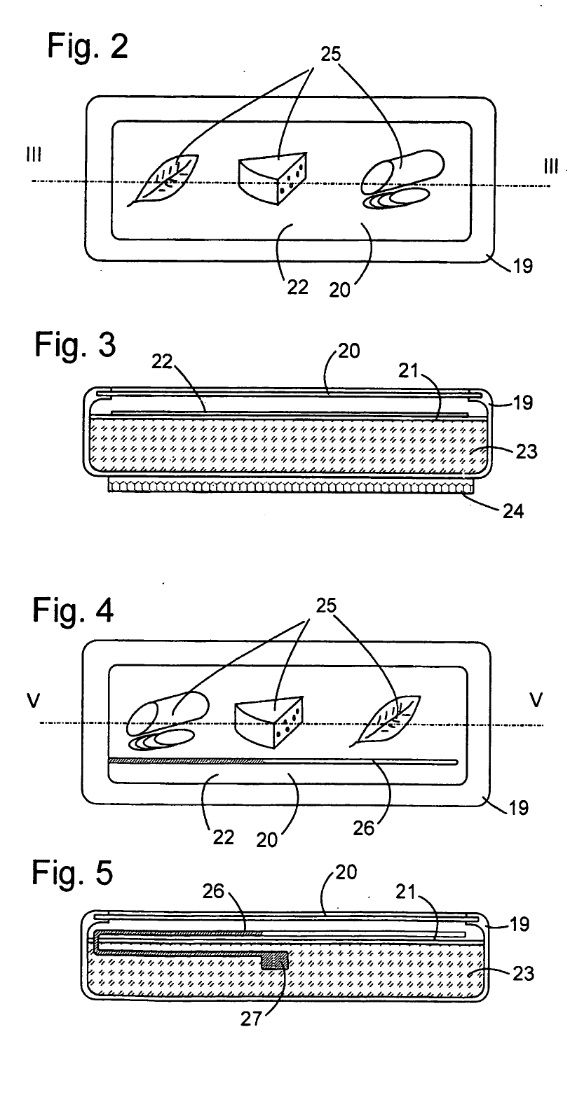

The individual regions 5, 5′, 8, 9 are each associated with a display element 10, 11, 12, 13, 14, 15, 16, 17 that is provided to indicate to a user which type of article can, expediently, be stored in the relevant region. The display elements 10 to 17 differ in each case in the way in which they are fitted; their construction may be identical and will be described at a later stage in the text with reference to FIGS. 2 to 5.

Two display elements 10 are each associated with the regions 5′ and are each fastened on a front side of one of the drawers 18. Each display element 10 is, expediently, disposed in the interior of the associated drawer 18 in each case. As a result, the display element 10 is subjected directly to the temperature prevailing in the drawer and can be seen and read through the transparent front side of the drawer 18.

A display element 11 is clamped onto the front edge of a shelf 4 such that it hangs down. It is associated with the region 5 beneath the relevant shelf 4, hangs into this region and is exposed to the temperature thereof. To not obstruct loading and unloading of the refrigerator in the region 5, the display element 11 is connected expediently in a pivotable manner to the shelf 4. As a result, it can easily be pivoted up by articles moving therepast and, then, returns into its position shown.

A further display element 12 is disposed on a front edge of a shelf 4 such that it projects upward into the associated region 5. This display element is also connected in a pivotable manner to the front edge of its shelf 4 and is provided with a spring that returns it into the position shown when it has been pivoted during loading or unloading of articles in the relevant region 5. The manner in which the display element 12 is fitted has the advantage, over the way in which the element 11 is fitted, that the local temperature to which the display element 12 is exposed is closer to the average temperature of the associated region 5 than in the case of the display element 11, which is located at a comparatively warm location of its region.

A display element 13 is fastened beneath a glass panel of a shelf 4 and can be read through this glass panel in a manner similar to the display elements 10. Because the display element 13 can be placed at a distance from the front edge of the shelf 4, the temperature to which it is exposed is, generally, more representative of the average temperature of the associated region 5 than in the case of the display elements 11 and 12.

A display element 14 is fastened on one of the side walls 3 of the refrigerating compartment 1. This fitting method has the advantage that the position of the display element 14 on the side wall 3 is largely freely selectable and can be fixed such that the display element 14 is exposed normally to a temperature that is very close to the average temperature of the associated region 5.

A display element 15 is disposed on the rear wall 6 in its associated region 5 of the refrigeration compartment 1. This rear wall 6 is generally colder than the region 5 cooled by it. To avoid the information displayed by the display element 15 from being falsified, a thermally insulating layer may be provided on the rear side of the display element 15, the rear side being directed towards the rear wall 6.

Further display elements 16, 17, which are associated with the regions 8, 9 formed on the door 7, are fastened on an inner cladding of the door 7.

Of the above-described display elements 11 to 15 fitted in different ways, use will, generally, be made, in the refrigeration compartment 1, of just a single type for all the regions 5, so that the way in which the individual display elements are associated with the respective regions remains easily understandable to a user.

FIGS. 2 and 3 show, in a respective front view and a section along line III-III from FIG. 2, a first exemplary embodiment of a display element 5 that can be used as one of the display elements 10 to 17. Installed in a housing 19 made of plastic, behind a transparent panel 20, is a carrier plate 21 that, on a side that is directed toward the panel 20, embedded in a film 22, bears different materials that change color in dependence on the temperature. The materials each are disposed in the form of symbols 25 that give ideographic illustrations of various typical articles—in the example illustrated in FIG. 2, vegetables, dairy products, and meat products, each having different optimum storage temperatures. The change in color of these materials gives the user an indication as to which type of article the region to which the display element belongs is suitable.

In the case of the display elements 10, 13, the transparent front side of the drawer or the panel of the shelf 4 may serve as the panel 20.

Located on the rear side of the carrier plate 21, the rear side being directed away from the panel 20, is a chamber 23 filled with a heat store, e.g., a brine. By the heat store, the speed at which the display element follows a change in ambient temperature is slowed down to the extent where periodic changes in the temperature that are associated with the intermittent operation of a refrigerating machine of the refrigerator do not result in a change of the information display.

Layers of insulating material may be provided as further measures for slowing down the speed at which the display element follows ambient-temperature change. Such a layer may be positioned around the chamber 23 wherever it does not block or obstruct the view of the symbols 23 or, in particular, in the case of the display element 15, as has already been mentioned above, it may be fitted merely on the rear side of the display element, e.g., in the form of a layer 24 of a foam material. It is also possible for an air gap between the panel 20 and the carrier plate 21 to serve as thermal insulation.

FIGS. 4 and 5 show a second configuration of a display element, in a front view and a section along line V-V from FIG. 4. The housing, the panel 20, the carrier plate 21, and the chamber 23 filled with a heat store are the same as those described above with reference to FIGS. 2 and 3. Symbols or pictograms 25 for different types of article are printed directly onto the carrier plate 21 or adhesively bonded thereto. Along the symbols 25, a tube 26 of a thermometer extends transversely over the carrier plate 21, the supply container 27 of the thermometer being embedded in the heat transfer media within the chamber 23. A liquid column within the tube 26 extends as far as the symbol 25 of that article of which the optimum storage temperature corresponds to the temperature of the heat store.

It would, of course, also be possible in this configuration for the symbols 25 to be replaced by a temperature scale divided into degrees.

The display element according to FIGS. 4 and 5 forms a compact, easy-to-install unit. Of course, the housing may also be in any other desired form; in particular, it is possible to configure the housing such that the chamber 23 with the brine and the supply container 27 end up located in the refrigerator at a central location of a region, e.g., approximately centrally on a shelf, although the carrier plate 21 with the symbols 25 and the tube 26 end up located at a position that can easily be seen by a user, in particular, on the front edge of the shelf.

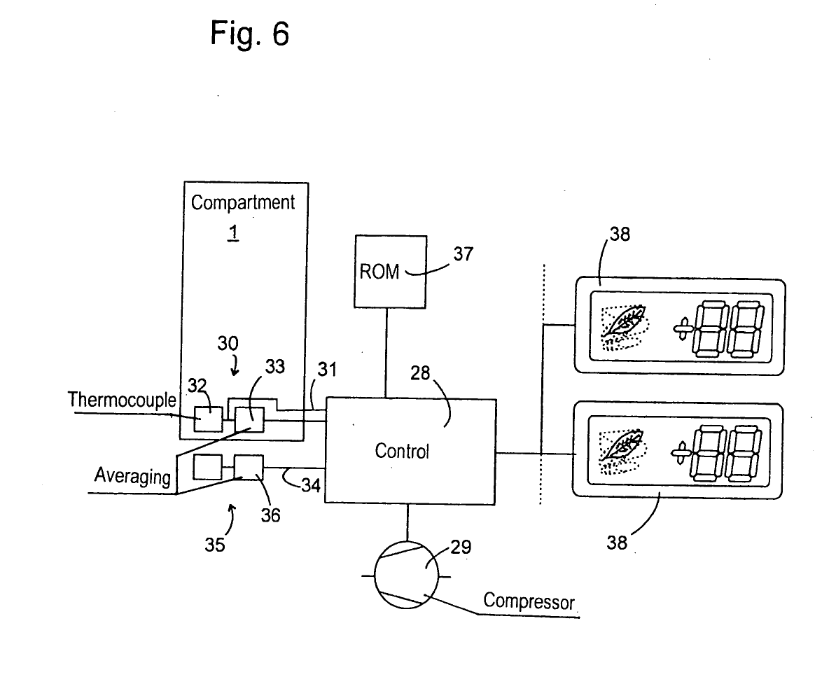

A third configuration of the refrigerator according to the invention is illustrated schematically in FIG. 6. A control unit 28 of the refrigerator controls the operation of the compressor 29 of a refrigerating machine in a manner known per se by way of the sensing resulting from a temperature sensor 30, the latter being disposed in a refrigerating compartment 1 and being transmitted to the control unit 28 through a line 31. The sensing signal transmitted over the line 31, e.g., a pronounced thermal e.m.f. of a thermocouple 32, reacts promptly to changes in the temperature in the refrigerating compartment 1. The temperature sensor 30, furthermore, includes an averaging circuit 33, e.g., an RC element, which receives the output signal of the thermocouple 32 and supplies to the control unit 28 a sliding average of the thermal e.m.f. averaged with the predetermined time constant. In FIG. 6, the averaging circuit 33 is illustrated separately from the control unit 28 and is connected to the latter through a dedicated line 34; it is, nevertheless, possible, of course, to provide the control unit 28 and the averaging circuit 33 in a common circuit, e.g., a microprocessor. Like the heat store of the previous configurations, the averaging circuit 33 serves for averaging out temporal fluctuations in the refrigerating compartment 1 that result from the intermediate operation of the refrigerating machine.

A second temperature sensor 35, which is, likewise, provided with an averaging circuit 36, is disposed on the refrigerator to sense the ambient temperature thereof, and is connected to the control unit 28. By way of the averaged temperatures supplied by the averaging circuits 33, 36, and of a known heat conduction behavior of the refrigerating compartment 1, the control unit 28 is capable of calculating, for the various regions of the refrigerating compartment 5, the average temperature prevailing therein. This calculation could take place, in principle, by virtue of solving a heat conduction differential equation; a more straightforward solution, however, is to use a look-up table in a read-only memory 37 that is connected to the control unit 28, and in which the manufacturer of the refrigerator has recorded temperature values that are measured for combinations of the two averaged temperatures in each case on a prototype of the refrigerator, for the various regions of the latter.

A plurality of display elements 38 are also connected to the control unit 28, these display elements 38 being fitted in the interior of the refrigeration compartment 1 at a clearly visible location of the region 5 to which they are associated.

As an alternative, or in addition, it is also possible for such display elements 38 to be fitted on an outer side of the refrigerator housing, in particular, the front side. The configuration of the display elements 38 relative to one another corresponds to the configuration of the regions in the refrigerating compartment. As a result, it is immediately apparent to a user, from the position of a display element 38, to which region the displayed information relates.

The display elements 38 are configured, for example, as LED or LCD displays. In the case of the display elements 38 shown in FIG. 6, a symbol corresponding to the symbols 25 from FIGS. 2 and 4 can be displayed in one region of the display panel in each case, and depending on the temperature estimated by the control unit 28 for the associated region 5, a second region serves for displaying the estimated temperature numerically. For the purposes of the invention, it would also be sufficient if just one of the two regions were present. As an alternative, it would also be possible to use a display element for which a plurality of symbols are disposed on a carrier plate, in a manner similar to those illustrated in FIG. 2 and each of these symbols is associated a light source that is intended for illuminating or back-lighting the symbol and can be activated selectively by the control unit 28.

1. A refrigerator, comprising:
a housing defining at least one refrigerating compartment having:
a global local and temporal fluctuation bandwidth of temperatures prevailing therein;
regions each having a regional local and temporal fluctuation bandwidth of temperatures prevailing therein smaller than said global fluctuating bandwidth; and
a display element associated with at least one of said regions for displaying information representative of a temperature interval prevailing in said at least one of said regions; and
a door removably closing off said compartment.

2. The refrigerator according to claim 1, wherein said display element is fitted in said refrigerating compartment locally in relation to said at least one region to which it is associated.

3. The refrigerator according to claim 1, wherein:
said housing has a front side; and
said display element is fitted on said front side of said housing.

4. The refrigerator according to claim 1, wherein said refrigerating compartment is divided up into a first group of at least one region in a vicinity of said door and a second group of at least one region remote from said door.

5. The refrigerator according to claim 1, wherein said refrigerating compartment has at least one shelf forming a boundary between said regions.

6. The refrigerator according to claim 1, wherein said display element displays changing information.

7. The refrigerator according to claim 6, wherein said changing information is numerical temperature information.

8. The refrigerator according to claim 6, wherein said changing information is at least one of text and pictographic indications of articles to be stored in at least one of said regions.

9. The refrigerator according to claim 6, further comprising:
a first temperature sensor for sensing a temperature in an associated one of said regions; and
said display element is coupled to said first temperature sensor.

10. The refrigerator according to claim 6, further comprising:
a refrigerating unit; and
a control unit programmed:
to control operation of said refrigerating unit based upon a predetermined desired temperature and at least one temperature sensed in said housing; and
to activate said display element dependent upon said at least one temperature sensed.

11. The refrigerator according to claim 10, further comprising:
a first temperature sensor disposed in said refrigerator compartment and sensing a temperature in said refrigerator compartment;
a second temperature sensor disposed at said housing and sensing a temperature in the environment of said housing; and
said control unit being connected to at least one of said first temperature sensor and said second temperature sensor.

12. The refrigerator according to claim 11, wherein said control unit has an information table to be displayed in dependence upon values of said sensed temperature in said refrigerator compartment and said sensed temperature in the environment of said housing.

13. The refrigerator according to claim 12, wherein:
said refrigerating unit operates intermittently; and
said first temperature sensor senses a temperature averaged with a time constant selected to average out temperature fluctuations associated with the intermittent operation of said refrigerating unit.

14. The refrigerator according to claim 13, wherein said first temperature sensor has an electronic average circuit.

15. The refrigerator according to claim 13, further comprising at least one of:
a thermally insulating material disposed between said first temperature sensor and surroundings of said first temperature sensor for slowing down temperature equalization between said first temperature sensor and surroundings of said first temperature sensor; and
a heat store in thermal contact with said first temperature sensor and the surroundings of said first temperature sensor.

16. In a refrigerator having a housing defining at least one refrigerating compartment and a door removably closing off the compartment, the compartment having a global local and temporal fluctuation bandwidth of temperatures prevailing therein and regions each having a regional local and temporal fluctuation bandwidth of temperatures prevailing therein smaller than the global fluctuating bandwidth, a display device comprising:
a display element associated with at least one of the regions for displaying information representative of a temperature interval prevailing in the at least one of the regions.

17. A refrigerator, comprising:
a housing defining at least one refrigerating compartment having:
a global fluctuation bandwidth of temperatures prevailing therein;
regions each having a regional fluctuation bandwidth of temperatures prevailing therein smaller than said global fluctuating bandwidth, said regions including at least one region in a vicinity of said door and at least one region remote from said door; and
a display element disposed is at least one of said regions for displaying information representative of a temperature interval prevailing in said at least one of said regions; and
a door removably closing off said compartment.

18. The refrigerator according to claim 17, further comprising at least one shelf in said compartment forming a boundary between at least two of said regions;

19. The refrigerator according to claim 17, wherein said display element has a temperature sensor for sensing a temperature in said at least one of said regions.

20. The refrigerator according to claim 17, wherein said temperature sensor senses a temperature averaged with a time constant selected to average out temperature fluctuations associated with said at least one of said regions.

21. The refrigerator according to claim 19, further comprising at least one of:
a thermally insulating material disposed between said temperature sensor and surroundings of said temperature sensor for slowing down temperature equalization between said temperature sensor and surroundings of said temperature sensor; and
a heat store in thermal contact with said temperature sensor and the surroundings of said temperature sensor.
